(19) United States
(12) Patent Application Publication
(10) Pub. No.: US 2022/0345083 A1
(43) Pub. Date: Oct. 27, 2022

(54) FLUID COOLING OF PHOTOVOLTAIC CELLS AND DESALINATION USING HEAT EXTRACTED THEREFROM

(71) Applicant: Hillery Thomas Kemp, Many, LA (US)

(72) Inventor: Hillery Thomas Kemp, Many, LA (US)

(21) Appl. No.: 17/764,069

(22) PCT Filed: Sep. 22, 2020
(86) PCT No.: PCT/US2020/052049

§ 371 Date: Mar. 25, 2022

Related U.S. Application Data
(60) Provisional application No. 62/973,312, filed on Sep. 27, 2019.

(51) Int. Cl. H02S 40/42; C02F 1/14

(52) U.S. Cl. CPC H02S 40/425; C02F 1/14

(57) ABSTRACT

To offset waste heat generated by a photovoltaic cell during operation, a cooling system is coupled to the photovoltaic cell. The cooling system is coupled to a surface of the photovoltaic cell opposite another surface of the photovoltaic cell on which solar energy is incident. In various embodiments, the cooling system includes one or more tubes through which fluid is directed. The fluid for cooling the photovoltaic cell may be contaminated water that is directed to one or more solar desalination stills after absorbing heat from the photovoltaic cell to product distilled water. After being further heated by the solar desalination still, water may be directed to a membrane distillation module which produces additional distilled water from the water heated by the solar desalination still and by the photovoltaic cell.

### BACKGROUND

This invention relates generally to heat energy recovery, and more to recovering heat generated by a photovoltaic cell. The invention is also related to desalination using stills powered by the recovered heat.

Photovoltaic cells generate electricity from solar energy incident on a surface of a photovoltaic cell. A photovoltaic cell typically converts approximately 10% of solar energy incident on the photovoltaic cell into electricity, with the remaining amount of solar energy converted into heat. Many conventional photovoltaic cells rely on air flow surrounding the photovoltaic cell to dissipate the generated heat and prevent overheating. However, such air cooled photovoltaic cells result in a heat island effect surrounding the photovoltaic cells. This heat island effect increases ambient air temperature proximate to the photovoltaic cells.

### SUMMARY

To offset waste heat generated by a photovoltaic cell during operation, a cooling system is coupled to the photovoltaic cell. The cooling system is coupled to a surface of the photovoltaic cell opposite another surface of the photovoltaic cell on which solar energy is incident. In various embodiments, the cooling system includes one or more tubes through which fluid is directed. For example, the cooling system includes multiple tubes each arranged in a spiral shape originating at a common point. Fluid flow through the tubes may be modified by altering openings in the tubes through which fluid enters and through which heated fluid exits. The fluid absorbs heat generated by the photovoltaic cell and the heated fluid is directed away from the photovoltaic cell. In various embodiments, the fluid is contaminated or otherwise non-potable water.

Heating of contaminated or otherwise non-potable water from the photovoltaic cell may be leveraged to generate distilled water from the contaminated water. In various embodiments, water heated by operation of a photovoltaic cell is directed to one or more solar desalination stills. A solar desalination still further heats the contaminated water, creating vapor that is condensed by the solar desalination still to distilled water. In various embodiments, the solar desalination still comprises one or more heating/evaporation sections that further heat the heated contaminated water from the photovoltaic cell and one or more cooling/condensing sections where water vapor generated by the one or more heating/evaporation sections condenses to generate distilled water.

Contaminated water further heated by the one or more solar desalination stills is directed to a membrane distillation module in some embodiments. The membrane distillation module includes a surface, such as a hydrophobic membrane, allowing vapor from the contaminated water heated by the photovoltaic cell and the one or more solar desalination stills to pass through the hydrophobic membrane while blocking the liquid heated contaminated water. Vapor passing through the surface is subsequently cooled on an opposite side of the surface than the heated contaminated water to be condensed into distilled water. Directing contaminated water that has absorbed heat from the photovoltaic cell through one or more solar desalination stills and through the membrane distillation module production of five to seven times more distilled water from an amount of solar energy than can be produced by conventional techniques from the amount of solar energy, while more efficiently cooling photovoltaic cells.

### BRIEF DESCRIPTION OF THE DRAWINGS

FIG. 1 is a system environment including a photovoltaic (PV) cell with a cooling system coupled to a solar desalination still, in accordance with an embodiment.

FIG. 2 is a cross-sectional view of one embodiment of a photovoltaic cell including a cooling system, in accordance with an embodiment.

FIG. 3 is an example configuration of a plurality of tubes for cooling a photovoltaic panel, in accordance with an embodiment.

FIG. 4 is an exploded view of a cooling system coupled to a photovoltaic panel, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Environment

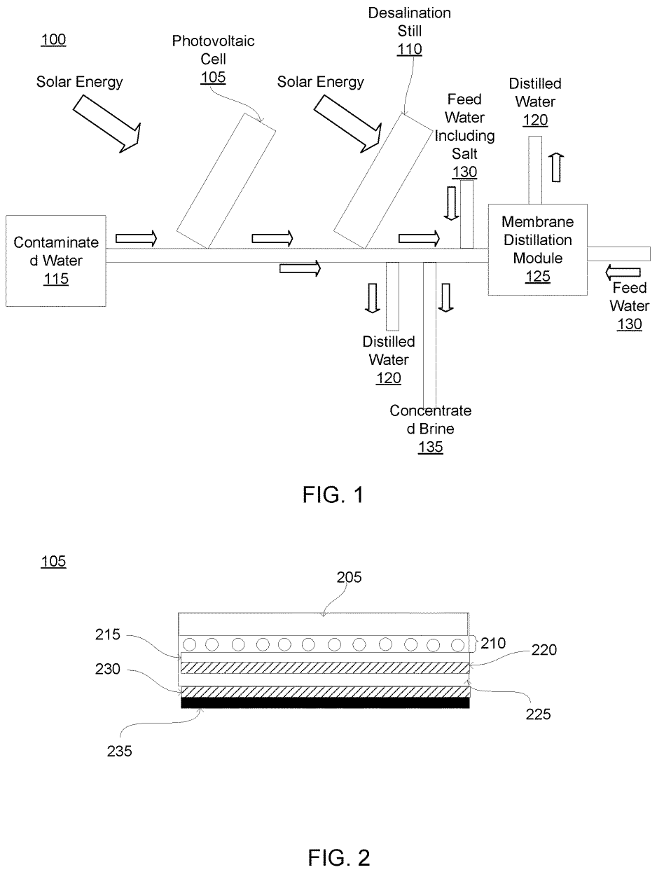

FIG. 1 is an example system environment 100 including a photovoltaic (PV) cell 105 with a cooling system coupled to a solar desalination still 110. While FIG. 1 shows an example including a single solar desalination still 110 for purposes of illustration, in other embodiments the system environment 100 includes multiple solar desalination stills 110.

Solar energy incident on the photovoltaic cell 105 causes the photovoltaic cell 105 to generate electrical power that may be directed to one or more devices coupled to the photovoltaic cell 105. Generation of the electrical power by the photovoltaic cell 110 produces waste heat. To offset the generated waste heat, photovoltaic cell 105 includes a cooling system, and in the embodiment of FIG. 1, the cooling system of the photovoltaic cell 105 receives contaminated water 115, such as water including salt or water that is otherwise non-potable. As further described below in conjunction with FIG. 2, the cooling system of the photovoltaic cell 105 directs the contaminated water 115 through cooling tubes proximate to, or contacting, components of the photovoltaic cell 105 to absorb heat from the components of the photovoltaic cell 105, heating the contaminated water 115.

After absorbing heat from the photovoltaic cell 105, the heated contaminated water 115 is directed from the photovoltaic cell 105 to the solar desalination still 110. While FIG. 1 shows an example with a single solar desalination still 110, in other embodiments, multiple solar desalination stills 110 are connected in series, so the heated contaminated water 115 is directed through multiple solar desalination stills 110. The solar desalination still 110 further heats the contaminated water 115 previously heated by absorbing heat from the photovoltaic cell 105, generating vapor that is condensed into distilled water 120. By further heating the contaminated water 115 from the photovoltaic cell 105, the solar desalination still 110 converts a portion of the heated contaminated water 115 to distilled water 120. In various embodiments, the solar desalination still 110 comprises one or more heating/evaporation sections that further heat the heated contaminated water 115 and one or more cooling/condensing sections where water vapor generated by the one or more heating/evaporation sections condenses to generate distilled water. For example, a heating/evaporation section comprises cloth or another material saturated with the heated contaminated water 115, and a cooling/condensing section comprises one or more coils on which water from the further heated contaminated water 115 condenses. Examples of a solar distillation still 110 are further described in U.S. Pat. No. 8,088,257, issued Jan. 3, 2012, and in U.S. Pat. No. 8,580,085, issued Nov. 12, 2013, each of which is hereby incorporated by reference in its entirety.

If multiple solar desalination stills 110 are coupled in series, the heated contaminated water is further heated when passing through each solar desalination stills 110, so each solar desalination still 110 further heats the heated contaminated water 115. In some embodiments, supplemental energy is provided to the solar desalination still 110 to aid in heating the contaminated water 115 previously heated by the photovoltaic cell 105. Example sources of supplemental energy for the solar desalination still 110 include waste heat, geothermal heat, or other heat sources. Further, concentrated brine is removed from the solar desalination still 110, which may be evaporated to dry salt.

Additionally, the further heated contaminated water 115 from the solar desalination still 110 is directed to a membrane distillation module 125 that produces additional distilled water 120 from a portion of the further heated contaminated water 115. The membrane distillation module 125 includes a surface, such as a hydrophobic membrane, allowing vapor from the further heated contaminated water 115 to pass through the hydrophobic membrane while blocking the liquid further heated contaminated water 115. The vapor passing through the surface (e.g., hydrophobic membrane) is subsequently cooled on an opposite side of the surface than the further heated contaminated water 115 to be condensed into distilled water, where the opposite side of the surface has a lower temperature than the side of the surface including the further heated contaminated water 115. The temperature difference between the side of the surface including the further heated contaminated water 115 and the opposite side of the surface creates a pressure difference causing vapor from the further heated contaminated water 115 to pass through the surface to the cooler opposite side of the surface where it condenses. Directing contaminated water 115 that has absorbed heat from the photovoltaic cell 105 through one or more solar desalination stills 110 and through the membrane distillation module 125 allows the system environment 100 described in conjunction with FIG. 1 to produce an amount of distilled water 120 from an amount of solar energy that is five to seven times greater than an amount of distilled water produced by conventional techniques from the amount of solar energy.

The remaining portion of the further heated contaminated water 115 water including salt that is not converted to distilled water 120 remains warmed contaminated water. Additional feed water 130, which may also be contaminated water, is added to the membrane distillation module 125 and to the solar desalination still 110 to compensate for the contaminated water 115 that the membrane distillation module 125 and the solar desalination still 110 used to produce distilled water 120.

While FIG. 1 shows a system environment 100 where fluid heated by a photovoltaic cell 105 is directed to a solar desalination still 110 and to a membrane distillation module 125 to produce distilled water, in other embodiments, fluid heated by the photovoltaic cell 105 may be further heated by an alterative heat source before being directed to the membrane distillation module 125. For example, a heating element is coupled to the photovoltaic cell 105 and generates heat from electricity generated by the photovoltaic cell 105. The heating element further heats fluid that has absorbed heat from the photovoltaic cell 105, increasing the heat of the fluid before the fluid is directed to the membrane distillation module 125. In other embodiments, the heating element may use any suitable heat source to further heat fluid that has absorbed heat from the photovoltaic cell 105. Example heat sources include waste heat, geothermal heat, or heat from any other suitable source.

### Cooling of Photovoltaic Cell

FIG. 2 is a cross-sectional view of one embodiment of a photovoltaic cell 105 including a cooling system. As shown in FIG. 2, the photovoltaic cell 105 includes a photovoltaic panel 205 configured to generate electricity from solar energy incident on the photovoltaic panel 205 through a photovoltaic effect. The photovoltaic panel 205 may comprise crystalline silicon or thin file modules in various embodiments.

A cooling system comprising a plurality of tubes 210 through which a fluid, such as water, passes. The plurality of tubes 210 contact a surface of the photovoltaic panel 205 that is opposite a surface of the photovoltaic panel 205 on which solar energy is incident. Alternatively, the plurality of tubes 210 are within a threshold distance of the surface of the photovoltaic panel 205 that is opposite the surface of the photovoltaic panel 205 on which solar energy is incident. As the photovoltaic panel 205 generates electricity from incident solar energy, heat is also produced, and the fluid passing through the plurality of tubes 210 absorbs the generated heat. After absorbing the heat, the fluid passing through the plurality of tubes 210 is directed away from the photovoltaic panel 205. Conventional photovoltaic panels use air flow dissipating heat produced by generation of electricity, causing air proximate to the surface of the photovoltaic panel 205 that is opposite the surface of the photovoltaic panel 205 on which solar energy is incident to be warmer relative to other locations. The fluid passing through the plurality of tubes 210 absorbs this heat, preventing localized warming of air proximate to the surface of the photovoltaic panel 205 that is opposite the surface of the photovoltaic panel 205 on which solar energy is incident to be warmer relative to other locations. As further described above in conjunction with FIG. 1, the fluid passing through the plurality of tubes 210 may be directed to one or more solar desalination stills 115 after absorbing head from the photovoltaic panel 205.

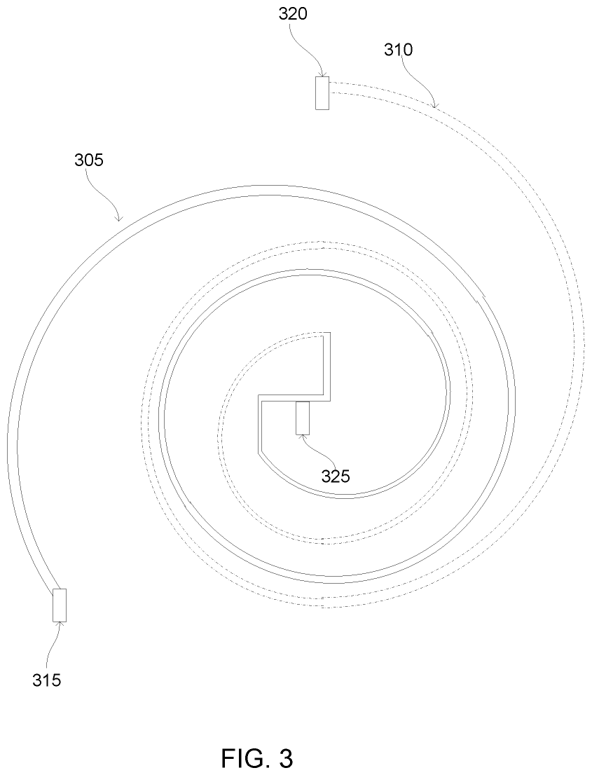

FIG. 3 shows an example configuration of the plurality of tubes for cooling the photovoltaic panel 205. In the example shown by FIG. 3, a tube 305 is formed into a spiral shape, while an additional tube 310 is formed into an additional spiral shape. The tube 305 and the additional tube 310 are positioned so the spiral and the additional spiral originate at a common point and emanate from the common point in different directions. In various embodiments, the common point for the spiral and the additional spiral is within a threshold distance of a center of the photovoltaic panel 205. The tube 305 has an orifice 315 at an end and a central orifice 325 at an opposite end, with the opposite end proximate to the common point. Similarly, the additional tube 310 has an additional orifice 320 at an end, with the opposite end of the additional tube 310 terminating at the central orifice 325. Hence, the central orifice 325 is shared between the tube 305 and the additional tube 315.

The orifice 315, the additional orifice 320, and the central orifice 325 allow directionality of fluid flow through the tube 305 and the additional tube 310 to be varied to account for changes in temperature and solar energy incident on the photovoltaic panel 205. In one configuration, fluid enters the tube 305 through the orifice 315 and enters the additional tube 310 through the additional orifice 320. The fluid travels through the tube 305 and the additional tube 310 absorbing heat, with the heated fluid directed out of the tube 305 and the additional tube 310 through the central orifice 325. Such a configuration with fluid entering through the orifice 315 and through the additional orifice 325 provides improved cooling of the photovoltaic panel 205 at warmer temperatures or when higher solar energy is incident on a surface of the photovoltaic panel 205. Alternatively, fluid enters the tube 305 and the additional tube 310 through the central orifice 325 and travels through the tube 305 and the additional tube to absorb heat. The heated fluid is directed out of the tube 305 through the orifice 315 and is directed out of the additional tube 310 through the additional orifice 320. In another configuration, fluid enters the tube 305 through the orifice 315, with a connector coupling the tube 305 and the additional tube 310 to the central orifice 325 configured to direct fluid from the tube through the connector to the additional tube 310 rather than out of the central orifice 325. Hence, fluid travels through the tube 305 and through the additional tube 315 absorbing heat before being directed out of the additional orifice 320. Using the orifice 315 to receive fluid and the additional orifice 320 to output heated fluid provides improved cooling of the photovoltaic panel 205 in cooler temperatures or when lower solar energy is incident on a surface of the photovoltaic panel 205. In some embodiments, a controller is coupled to a fluid reservoir and to valves located at the orifice 315, the additional orifice 320, and the central orifice 325. Based on temperature or solar energy incident on the photovoltaic panel 205, the controller modifies the valves to adjust how fluid flows through the tube 305 and the additional tube 315 to adjust cooling of the photovoltaic panel 205 in different conditions. As solar energy incident on the photovoltaic panel 205 changes over time as the angle of the sun incident on the photovoltaic panel 205 changes, adjusting fluid flow through the tube 305 and through the additional tube 315 allows for optimization of cooling of the photovoltaic panel 205 to optimize heating of the fluid, to optimize electrical power production by the photovoltaic panel 205, or to optimize both electrical power production and fluid heating, depending on implementation and conditions surrounding the photovoltaic panel 205.

Referring back to FIG. 2, the plurality of tubes 210 are coupled to a support structure 215. For example, the support structure 215 is a frame to which the plurality of tubes 210 are coupled at one or more locations. For example, the support structure 215 is configured as a cross to which the plurality of tubes 210 are coupled. The support structure 215 maintains positioning of the plurality of tubes 210 relative to each other, allowing space between different tubes 210 to be maintained.

The plurality of tubes 210 and the support structure 215 are positioned within a container 225. In some embodiments, the container 225 is a pan comprising galvanized material (e.g., galvanized steel), while in other embodiments the pan comprises a corrosion resistant material. Additionally, insulating material 220 may be positioned between the support structure 215 and a surface of the container 225 in one embodiment. For example, the insulating material 220 comprises one or more foam panels. In some embodiments, the insulating material 220 is positioned at locations in the container 225 where the support structure 215 does not contact the container 225, while in other embodiments one surface of the insulating material 220 contacts the support structure 215 and an opposite surface of the insulating material 220 contacts the container 225.

Additional insulating material 230 contacts a surface of the container 225 opposite a surface contacting the insulating material 220 or the support structure 215. In various embodiments, the additional insulating material 230 is adhered to the surface of the container 225. A rigid surface 235 is coupled to a surface of the additional insulating material 230 opposite the surface of the additional insulating material 230 contacting the container 225. For example, the rigid surface 235 is adhered to the surface of the additional insulating material 230. In various embodiments, the rigid surface 235 is a sheet of metal, such as galvanized metal. Adhering the additional insulating material 230 to the surface of the container 225 and to the rigid surface 235 creates a sandwich structure with the surface of the container 225 and the rigid surface 235 forming facesheets of the sandwich structure and the additional insulating material 230 forming a core structure supporting the container 225 and the rigid surface 235. This sandwich structure prevents the plurality of tubes 210 from moving away from the photovoltaic panel 205.

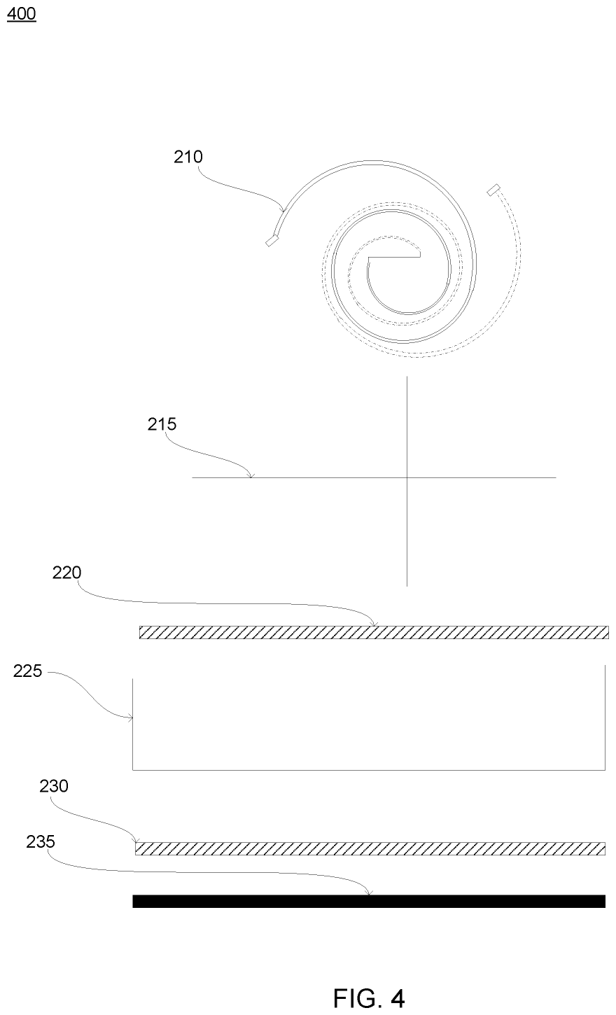

FIG. 4 shows an exploded view of one embodiment of a cooling system 400 coupled to a photovoltaic panel. As further described above in conjunction with FIG. 2, the cooling system 400 includes a plurality of tubes 210 configured to be positioned proximate to or contacting a surface of a photovoltaic panel that is opposite another surface of the photovoltaic panel on which solar energy is incident. A fluid, such as water, flows through the plurality of tubes 210 and absorbs heat generated by the photovoltaic panel generating electricity from the incident solar energy. The plurality of tubes 210 direct the fluid away from the photovoltaic panel after the fluid absorbs heat. As further described above in conjunction with FIG. 1, the heated fluid may be directed to one or more solar desalination stills or to a membrane distillation module. In embodiments where the fluid comprises saltwater (or other contaminated water), directing the heated saltwater to the solar desalination stills or to the membrane distillation module causes a portion of the heated saltwater to be converted into distilled water. As further described above in conjunction with FIG. 3, the plurality of tubes 210 are configured in a dual spiral configuration to optimize fluid flow for cooling the photovoltaic panel.

The plurality of tubes 210 are coupled to a support structure 215 configured to maintain spacing between different tubes 210. For example, the support structure 215 is a cross structure to which the plurality of tubes 210 are coupled at different locations. The plurality of tubes 210 and the support structure 215 are enclosed in a container 225, such as a pan. The container 225 may be coupled to the surface of the photovoltaic panel opposite the surface of the photovoltaic panel on which solar energy is incident in various embodiments. Thermal paste may be included in the container 225 in various embodiments to improve heat transfer to the fluid flowing through the plurality of tubes 205. The thermal paste may be any suitable thermally conductive material or compound. In various embodiments, the thermal paste is thermally conductive and electrically insulating. Alternatively, the container 225 includes air, so heat is transferred from the photovoltaic panel to the fluid directed through the plurality of tubes 205 via the air enclosed by the container 225.

In some embodiments, the container also encloses insulating material 220, such as foam insulation. For example, the insulating material 220 comprises one or more foam panels. The insulating material 220 may be positioned between the support structure 215 and a surface of the container 225 in one embodiment. In some embodiments, the insulating material 220 is positioned at locations in the container 225 where the support structure 215 does not contact the container 225, while in other embodiments one surface of the insulating material 220 contacts the support structure 215 and an opposite surface of the insulating material 220 contacts the container 225.

Additional insulating material 230 is coupled to an exterior surface of the container 225 that is opposite a surface contacting the insulating material 220 or the support structure 215. In various embodiments, the additional insulating material 230 is adhered to the surface of the container 225. A rigid surface 235 is coupled to a surface of the additional insulating material 230 opposite the surface of the additional insulating material 230 contacting the container 225. As described above in conjunction with FIG. 2 positioning the additional insulating material between the container 225 and the rigid surface 235 prevents the plurality of tubes 210 from moving away from the photovoltaic panel 205.

In various embodiments, the cooling system 400 also includes a temperature control system. For example, the temperature control system monitors a rate at which fluid flows through the plurality of tubes 205 and away from a photovoltaic panel. In response to determining that the rate is less than a threshold value, the temperature control system performs one or more actions to prevent the photovoltaic panel from overheating. For example, the temperature control system repositions the cooling system 400 relative to the photovoltaic panel to increase air flow around the surface of the photovoltaic panel opposite the surface of the photovoltaic panel on which solar energy is incident, allowing the photovoltaic panel to be cooled by air flow. Alternatively, the temperature control system deactivates the photovoltaic panel in response to determining the rate of fluid flow through the plurality of tubes 205 is less than the threshold value. Similarly, the temperature control system may monitor a temperature of the surface of the photovoltaic panel to which the cooling system 400 is coupled and perform one or more of the actions described above, or other suitable actions, in response to the monitored temperature equaling or exceeding a maximum temperature.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a photovoltaic panel configured to have solar energy incident on a surface of the photovoltaic panel; and
a plurality of tubes positioned proximate to and thermally coupled with an additional surface of the photovoltaic panel that is opposite the surface, the plurality of tubes configured to direct a fluid through the plurality of tubes to be heated by heat generated by the photovoltaic panel and to direct the heated fluid away from the photovoltaic panel.

2. The system of claim 1, wherein the plurality of tubes comprise a tube formed into a spiral shape and an additional tube formed into an additional spiral shape, the tube and the additional tube positioned so the spiral and the additional spiral originate at a common point

3. The system of claim 2, wherein the spiral and the additional spiral and emanate from the common point in different directions.

4. The system of claim 2, wherein the tube has an orifice at an end and a central orifice at and opposite end that is proximate to the common point, and the additional tube has an additional orifice at an end of the additional tube and an opposite end of the additional tube terminating at the central orifice.

5. The system of claim 4, wherein the central orifice is configured to receive the fluid, and the orifice and the additional orifice are configured to direct the heated fluid away from the photovoltaic panel.

6. The system of claim 4, wherein the orifice and the additional orifice are configured to receive the fluid and the central orifice is configured to direct the heated fluid away from the photovoltaic panel.

7. The system of claim 4, wherein the orifice is configured to receive the fluid, a connector coupling the tube and the additional tube to the central orifice is configured to direct the fluid from the tube through the connector to the additional tube, and the additional orifice is configured to direct the heated fluid away from the photovoltaic panel.

8. The system of claim 1, wherein the fluid comprises contaminated water.

9. The system of claim 8, further comprising:
one or more solar desalination stills configured to receive the heated fluid from the plurality of tubes, a solar desalination still comprising one or more heating/evaporation sections and one or more cooling/condensing sections that generate distilled water from a portion of the heated fluid and further heated fluid from the remaining portion of the heated fluid.

10. The system of claim 9, further comprising:
a membrane distillation module configured to receive the further heated fluid from the one or more solar desalination stills, the membrane distillation module including a surface for extracting humidity from the further heated fluid and cooling capacity to condense the extracted humidity into distilled water.

11. The system of claim 1, wherein the plurality of tubes are enclosed in a container that is coupled to the additional surface of the photovoltaic panel.

12. The system of claim 11, further comprising:
insulated material coupled to a surface of the container opposite an additional surface that is proximate to the plurality of tubes; and
a rigid surface coupled to a surface of the insulated material opposite an addition surface of the insulated material that is coupled to the surface of the container.

13. The system of claim 12, wherein the rigid surface comprises a sheet of galvanized metal.

14. A device comprising:
a container configured to be coupled to a additional surface of a photovoltaic panel that is opposite an additional surface of the photovoltaic panel on which solar energy is incident, the container including:
a plurality of tubes positioned proximate to the surface of the photovoltaic panel, the plurality of tubes configured to direct a fluid through the plurality of tubes to be heated by heat generated by the photovoltaic panel and to direct the heated fluid away from the photovoltaic panel.

15. The device of claim 14, further comprising:
a support structure included in the container, each tube of the plurality of tubes coupled to the support structure at one or more locations.

16. The device of claim 15, further comprising:
insulating material positioned between a surface of the container and the plurality of tubes.

17. The device of claim 16, further comprising:
additional insulating material coupled to an exterior surface of the container opposite a surface of the container contacting the insulating material; and
a rigid surface coupled to a surface of the additional insulating material that is opposite a surface of the additional insulating material coupled to the exterior surface of the container.

18. The system of claim 17, wherein the rigid surface and the container comprise galvanized metal.

19. The system of claim 14, wherein the plurality of tubes comprise a tube formed into a spiral shape and an additional tube formed into an additional spiral shape, the tube and the additional tube positioned so the spiral and the additional spiral originate at a common point

20. The system of claim 18, wherein the spiral and the additional spiral and emanate from the common point in different directions.
